(19) United States
(12) Patent Application Publication
(10) Pub. No.: US 2004/0151890 A1
(43) Pub. Date: Aug. 5, 2004

(54) Polyvinyl acetal composition skinless roller brush

(76) Inventor: Thomas J. Drury, Tolland, CT (US)

Correspondence Address: JOHN S. HALE, GIPPLE & HALE, 6665-A OLD DOMINION DRIVE, MCLEAN, VA, 22101, US

(21) Appl. No.: 10/748,302

(22) Filed: Dec. 31, 2003

Related U.S. Application Data
(63) Continuation of application No. 09/838,138, filed on Apr. 20, 2001.

(51) Int. Cl. B32B 3/26; B32B 3/00

(52) U.S. Cl. 428/304.4; 428/315.5; 428/313.5

(57) ABSTRACT

A semiconductor cleaning device having a substantially cylindrical roller body made of polyvinyl acetal with a smooth outer surface and uniform material porosity having a mean flow pore pressure ranging from about 0.30 PSI to about 0.35 PSI with 95% of its pores ranging from 7 to 40 microns in size and a wet flow rate ranging from about 80.0 L/min to about 7.0 L/min.

### FIELD OF THE INVENTION

The present invention relates generally to cleaning devices for semiconductor wafer cleaning devices and more specifically relates to a roller constructed of a novel polyvinyl acetal composition with a uniform composition and no outer skin having an small average pore size allowing chemical flow through the roller body without clogging of the sponge pores and precluding sponge material destruction.

### BACKGROUND OF THE INVENTION

Many industries today require the ability to efficiently clean highly finished surfaces, removing particles and other surface contaminants. Specific articles having highly finished surfaces include, but are not limited to, wafers of semiconductor material, and memory disks.

The presence of foreign material on semiconductor wafers represents a serious problem in the manufacture of integrated circuits on semiconductor wafers. In the manufacturing process of same the wafers are initially polished to planarize the surface prior to subsequent processing of depositing the desired circuits. A combination of chemical and mechanical polishing is generally used which requires the introduction of polishing chemicals onto the surface of the semiconductor wafer as it is being polished or cleaned. The chemicals may contain fine abrasive particles and incorporate chemical cleaning compositions such as silica (SiO₂) and alumina (Al₂O₃). When the polishing is completed the semiconductor wafers must be cleaned to completely remove residual materials in order that the surface be made ready for subsequent photolithographic processing and other manufacturing steps.

Semiconductor wafers must be cleaned prior to any processing steps used to produce semiconductor devices. Currently used cleaning brushes or rollers have their pores clogged with chemicals and waste reducing flow and rapidly break down during the cleaning process.

Cleaning cylindrical brushes are used to clean the residual cleaning compositions from the surfaces of the semiconductor wafers. Devices for cleaning wafers generally consist of a cylindrical roller passing over a wafer. The cylindrical roller conventionally includes tufted nylon or other types of bristles extending from a central core. The bristle roller brushes are fixed horizontally and rotate as the wafer or memory disk is passed between the bristle surfaced brushes while the. surfaces receive large quantities of cleaning solution or de-ionized water.

Wafers cleaned in this manner are often unacceptable due to particles and other surface contaminants missed or passed over in the cleaning process. In addition, the softness of the bristles varies according to their composition, resulting in a heterogeneous mixture of bristles, each harder or softer than their counter parts. This results in breakage of the wafers as well as damage to wafer surfaces. Other drawbacks, resulting in unsatisfactory cleaning, may be attributed to the hydrophobic nature of bristle tufted brushes. The fiber surfaces of these brushes are never wetted, and require large amounts of de-ionized water or cleaning solution to work in the cleaning process. Cleaning devices using sponge material are generally more effective in cleaning a surface by removing particulate material and surface contaminates but break down because of pore clogging and surface ripping. It has not been effective to clean such brushes and they are generally discarded after an undesirable amount of residual cleaning composition has been built up in the pores of the brush. Since such brushes are relatively costly, the dirty brushes are sometimes utilized beyond the point where they should be replaced resulting in inconsistent levels of cleanliness on the wafers lowering the yield of semiconductor product wafers.

### DESCRIPTION OF THE RELATED ART

U.S. Pat. No. 4,098,728, discloses a polyvinyl acetal sponge and a method for making the same. In this method, pore spaces in the sponge are formed by gas bubbles; rather than pore forming chemical additives such as starch/sulfate combinations. Because the sponge disclosed in this patent does not have any starch residue, it has been particularly useful in medical applications in which starch residues can cause a foreign body reaction when in contact with human tissue.

The use of synthetic sponges, made of polyvinyl acetal for cleaning devices is well known. For example, U.S. Pat. No. 4,566,911 discloses a roller scrubbing device using a polyvinyl acetal material for cleaning semiconductor chips having a surface layer of elastic polyvinyl acetal material with an average pore diameter ranging from 10 to 200 microns. U.S. Pat. No. 6,080,092 discloses an industrial sponge roller device with a cylindrical body of polyvinyl acetal material and a plurality of projections of a truncated conical shape extending from an outer surface of the cylindrical body.

Conventional synthetic sponges have a polymer structure with “dead end pockets” formed therein that trap residue and trace amounts of metals and have non-uniform pore sizes causing fluid backup and residue deposit. As the sponge wears, these metals can come out of the sponge in the form of particulate matter. Such particulate matter can damage the surfaces that are to be cleaned. Further, this type of sponge has tiny fibrils in the pores thereof that are a result of spaces between the pore forming chemical additive during a cross-linking reaction. “Cross-linking” is the formation of ester bonding between chains of the two adjacent hydroxyl groups that occur with the reaction of polyvinyl alcohol and aldehyde. This reaction hardens and strengthens the resulting material.

Semiconductor wafers must be cleaned prior to any processing steps used to produce semiconductor devices. Due to the fragile nature of semiconductor wafers, achieving a high degree of cleanliness, as well as a high yield of clean wafers is difficult. Many cleaning devices produce a low yield of clean wafers due to breakage or an unacceptable level of surface contaminants. Memory discs provide less of a problem with breakage, being more durable.

It would be highly advantageous, therefore, to remedy the foregoing and other deficiencies inherent in the prior art.

### SUMMARY OF THE INVENTION

A substantially skinless cleaning roller of polyvinyl acetal having a uniform small pore size throughout the material in which over 90% of the pores of the material range from 7-40 microns in diameter with a mean flow pore diameter of about 20 microns and a mean flow pore pressure of 0.334 PSI. The flow rate through the material provide a dry flow ranging from 25.0 L/min to 25.0 L/min and a wet flow of about 80.0 L/min to 6.5 L/min.

Accordingly, it is an object of the present invention to provide a new and improved polyvinyl acetal sponge material for use in cleaning semiconductor wafers which has greater durability than prior sponge material with reduced surface pressure drop.

Another object of the present invention is to provide an improved even flow rate of cleaning solution from the center of the core of the roller to the outside of the diameter through the sponge material for even application of cleaning solution to the surfaces of the articles being cleaned without clogging.

It is another object of the invention to provide a material which allows better cleaning of surface materials using less cleaning solution and uniform solvent delivery at low rates.

It is still another object of the present invention is to provide an improved sponge material for cleaning semiconductors with better strength characteristics.

It is yet another object of the present invention to provide a sponge material capable of removing ultra-fine particles from hydrophobic surfaces and adding to the life usage of the sponge material used in cleaning the semiconductor wafers.

The present invention solves the above noted problems with cleaning sponges in a manner not disclosed in the known prior art.

In the accompanying drawings, there is shown an illustrative embodiment of the invention from which these and other objectives, novel features and advantages will be readily apparent.

### BRIEF DESCRIPTION OF THE DRAWINGS

FIG. 1 is a perspective view of a roller cleaning device made from the inventive sponge composition;.

FIG. 2 is a perspective view of a cleaning pad embodiment made from the inventive sponge composition;

FIG. 3 is a top plan view of a cleaning disk embodiment made from the inventive sponge composition; and

FIG. 4 is a side elevational view of the cleaning disk of FIG. 3.

### DETAILED DESCRIPTION OF THE PREFERRED EMBODIMENT

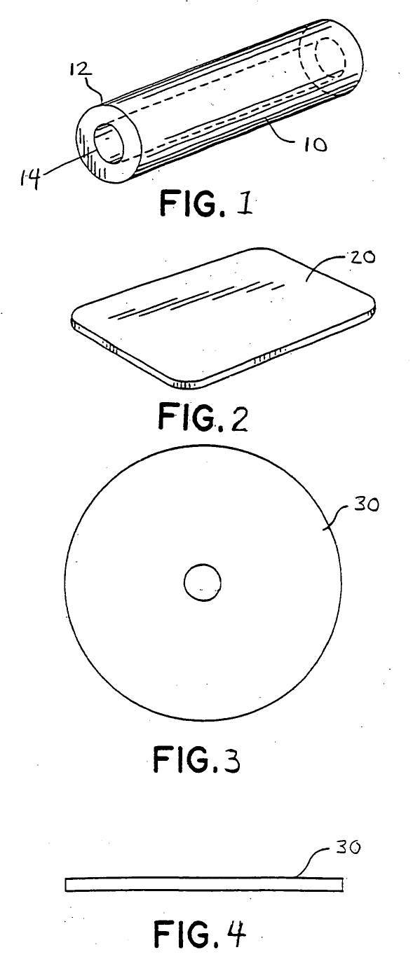

The best mode and the preferred embodiment of the novel semiconductor cleaning device of the present invention is shown generally in FIG. 1.

FIG. 1 is a perspective view of a roller 10 cleaning device according to embodiment of the present invention. This figure is merely an illustration and should not limit the scope of the claims herein. One of ordinary skill in the art would recognize other variations, modifications, and alternatives. The cleaning device can range in size and shape, depending upon the application. According to the preferred embodiment, the cleaning device is shaped as a cylindrical roller 10, which has a smooth outer surface 12 with a central hollow core 14. The outer surface 12 is substantially skinless and has homogeneous small pore distribution and sizing throughout the material of the roller. The roller 10 is constructed of polyvinyl acetal material and has an outer diameter of 60 mm and an inner diameter of 30 mm with a thickness of about 15 mm and has a length ranging from 6 inches to 18 inches and is able to hold tight specifications. The material has a consistent durometer ranging from between 5-9 depending on the wetness of the material and has a uniform small pore size which provides a flow through rate which does not put pressure on the roller or distort it during the cleaning process. This allows even flow of chemicals from the center of the core to the outside of the diameter without sacrificing strength. It is thus easier to pass chemistry through the roller and clean the same. Average flow requirements are reduced from 500-700 ml/minute to 120-180 ml/minute. The material has a higher rate for a better draw of debris, residue and chemistry from patterned wafer surfaces resulting in a cleaner and dryer end product. The brush rollers 10 can have shapes and sizes to meet the particular cleaning application for devices such as semiconductor wafers, hard disks, and other applications.

The porosity of the device is uniform with at least 90% and preferably about 95% of the pore sizes being below 40 microns with the average pore diameter size or opening being about 20 microns. The pore size diameter opening ranges from about 7 microns to about 40 microns. Thus, the material has good flow properties, thus making the performance of the cleaning roller 10, cleaning pad 20 and cleaning disk 30 highly satisfactory.

The cleaning roller 10 material has a pore ranging from the smallest detected pore diameter of 7.1912 microns with a smallest detected pore pressure of 0.923 PSI. The cleaning roller material has a mean flow pore diameter of 20.0 microns with a mean flow pore pressure of 0.334 PSI. The material has a bubble point pressure of 0.026 PSI and maximum pore size distribution of 5.1417 and a diameter at maximum pore size distribution of about 14.34 microns. In measuring the flow rate through the material, at least 90% and preferably 95% ofthe pores have a diameter size 7 microns through 40 microns with a dry flow ranging from about 95.0 L/min to about 25.0 L/min and a wet flow of about 80.0 L/min to 7.0 L/min. The flow was measured under the Darcy method of measuring flow using water as the fluid, with a fluid viscosity of 1.000 CP with an average Darcy Permeability Constant of 5.1849.

The method used to determine the aforenoted measurements for the material was a standard capillary flow analysis. It was surprisingly found that materials presently being used to clean semiconductors and that the rollers had greater strength and greater durability.

In a specific embodiment, the devices are made using a suitable material that is firm, porous, elastic, and has certain abrasion resistiveness. The primary raw starting material for the device is air blown polyvinyl alcohol which is used to form a polyvinyl acetal porous elastic material with a uniform cell structure. The porous material varies in characteristic depending upon cleanliness, type of pore forming agent or process, type of aldehyde employed for the conversion of a polyvinyl alcohol to a polyvinyl acetal, and other factors. These factors also include the relative proportions of reactants, reaction temperature and time, and the general condition and starting materials in the manufacturing process.

In manufacture, the base polyvinyl acetal material is heated and solubilized at about 190 degrees Fahrenheit, mixed with cross linking agent and catalyzed and placed into cast tubes or molds having the specific shape which is desired and slowly cured. After removing the molded polyvinyl acetal material from the cast, the shaped material is washed with a di-water carrier several times to remove the forming formaldehyde so that the formaldehyde is undetectable (under 1/2 part per million) by high pressure liquid chromatography but believed to be less than 0.1 part per million.

Any of a variety of substances can be introduced into the polyvinyl acetal materials (PVA) after washing to remove undesired residue, e.g, by soaking or immersing the PVA in a solution of the desired substance(s) followed by drying of the PVA.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A cleaning device comprising a body made of porous polyvinyl acetal material having a uniform pore size throughout the material with over 90% of the pores ranging from about 7 microns to about 40 microns in diameter.

2. A cleaning device as claimed in claim 1 wherein said device is a roller having a smooth outer surface.

3. A cleaning device as claimed in claim 1 wherein said device is a pad.

4. A cleaning device as claimed in claim 1 wherein said device is a disk.

5. A cleaning device as claimed in claim 1 wherein said polyvinyl acetal material has an average pore size of about 20 microns.

6. A cleaning device as claimed in claim 1 wherein said material has about 95% of its pores with a diameter below 40 microns.

7. A cleaning device comprising a body made of porous polyvinyl acetal material having a bubble point pressure of about, 0.92 PSI.

8. A cleaning device as claimed in claim 2 wherein said roller has an outside diameter of about 60mm and an inside diameter of about 30mm with a thickness of about 15 mm.

9. A cleaning device as claimed in claim 1 wherein said material has a mean flow pore pressure of about 0.33 PSI.

10. A semiconductor cleaning device comprising a body made of porous polyvinyl acetal material with a cylindrical roller shape and a smooth outer surface, said material having a uniform pore size throughout with at least 90% of the pores ranging from about 7 microns to about 40 microns in diameter with a fluid flow through rate which does not distort the roller during the cleaning process.

11. A semiconductor cleaning device as claimed in claim 10 wherein said polyvinyl acetal material has an average pore size of about 20 microns.

12. A semiconductor cleaning device as claimed in claim 10 wherein said material has 95% of its pores with a diameter below 40 microns.

13. A semiconductor cleaning device comprising a body made of porous polyvinyl acetal material having at least 95% of its pores with a diameter under 40 microns.

14. A semiconductor cleaning device as claimed in claim 10 wherein said roller is substantially skinless.

15. A semiconductor cleaning device as claimed in claim 10 wherein said material has a mean flow pore pressure of about 0.33 PSI.

16. A semiconductor cleaning device comprising a body made of porous polyvinyl acetal material having a uniform pore size throughout the material with at least 95% of the pores being less than 40 microns in diameter, said material having a mean flow pore diameter of about 20 microns.

17. A semiconductor cleaning device as claimed in claim 16 wherein said material has a mean flow-pressure of about 0.33 PSI.

18. A semiconductor cleaning device comprising a substantially cylindrical roller body made of polyvinyl acetal with a smooth outer surface and uniform material porosity having a mean flow pore pressure ranging from about 0.30 PSI to about 0.40 PSI with 90% of its pores ranging from 7 to 40 microns and wet flow rate using water as a medium ranging from about 9.0 L/min to 20.0 L/min

19. A semiconductor cleaning device as claimed in claim 18 wherein cleaning solvent flow through said roller ranges from 120-180 ml/minute.
